(19) United States
(12) Patent Application Publication
(10) Pub. No.: US 2008/0119606 A1
(43) Pub. Date: May 22, 2008

(54) Compositions of Additives for Plastics

(75) Inventors: Decio Malucelli, Ferrara (IT); Marco Consalvi, Occhiobello (Rovigo) (IT); Fiorella Pradella, (Mantova) (IT); Anna Fait, Ferrara (IT)

Correspondence Address: Basell USA Inc., Delaware Corporate Center II, 2 Righter Parkway, Suite #300, Wilmington, DE, 19803, US

(73) Assignee: BASELL POLIOLEFINE ITALIA S.R.L., MILAN (IT)

(21) Appl. No.: 11/793,192

(22) PCT Filed: Dec. 13, 2005
(86) PCT No.: PCT/EP05/56752

§ 371 Date: Jun. 14, 2007

Related U.S. Application Data
(60) Provisional application No. 60/664,481, filed on Mar. 23, 2005.

(30) Foreign Application Priority Data
Dec. 17, 2004 (EP) 04029976.0

(51) Int. Cl. C08L 23/00

(52) U.S. Cl. 524/570

(57) ABSTRACT

Compositions of additives for plastics comprising the following components (percent by weight):
A) from 1% to 25% of a polyolefin matrix comprising one or more polyolefins having a melting point of 160° C. or less, said melting point being determined by differential scanning calorimetry (DSC), according to ISO 11357;
B) from 75% to 99% of one or more solid additives for polymers.

This application is the U.S. national phase of International Application PCT/EP2005/056752, filed Dec. 13, 2005, claiming priority to European Patent Application 04029976.0 filed Dec. 17, 2004, and the benefit under 35 U.S.C. 119(e) of U.S. Provisional Application No. 60/664,481, filed Mar. 23, 2005; the disclosures of International Application PCT/EP2005/056752, European Patent Application 04029976.0 and U.S. Provisional Application No. 60/664,481, each as filed, are incorporated herein by reference.

The present invention relates to compositions of solid additives for plastics, comprising a blend of said additives with reduced amounts of one or more olefin polymers having a melting point of 160° C. or less. In particular it relates to such compositions in the form of strands, as well as to pellets of the same composition, obtainable by cutting or crushing the said strands.

Such strands have an elongated shape, with definite cross section. For “definite cross section” it is meant here that the cross area of the strands has a geometrically definable shape, like circular or polygonal (as, for example, square or triangular). For “elongated shape” it is meant that the distance between the two ends of the strands (hereinafter called “SL” for “Strand Length”), measured along the strand, is longer than the maximum linear (straight) length measurable on the cross area (hereinafter called “CL” for “Cross Length”). Preferably the ratio SL/CL for the strands is of 2 or more, in particular from 2 to 50, more preferably higher than 5. Under a SL/CL ratio of 5 and preferably of 2-3, it is proper to talk of pellets. As previously said, the SL length is measured along the strand, thus along a straight line when the strand is substantially straight, or a curved line when it is not straight.

The term “additive” is meant to embrace any substance that can be added to a base polymer, therefore any distinction between additives and other substances generally added to polymers is not valid in the present case, except that fillers and other reinforcing agents (like fibers, for example) are not considered to be additives according to the present invention.

Many additives commonly used for plastics are typically in the solid state, as their melting temperature is significantly higher than the room temperature (generally it is of 50° C. or more), and in powder form.

However it is known in the art that the processing of materials in powder form involves significant drawbacks, particularly as regards dust containment and metering into the polymer.

To avoid such drawbacks, various powder compaction solutions, also in the presence of polymeric components in powder form as well, have been proposed, as disclosed in particular in U.S. Pat. No. 5,846,656.

However, the technical solutions based on compaction of powdery components requires a careful control of the processing conditions and often involves recycling of the not agglomerated powder particles.

According to EP-A-1266932 it is possible to obtain non-powdery compositions of additives by granulating (extruding) a mixture of additives with polypropylene. In the examples a generically defined polypropylene powder is used (in amounts of 25% by weight or more). It is therefore to be assumed that, according to the said document, for polypropylene a conventional propylene polymer is meant. In consideration of the high temperatures at the exit of the extruder, the polypropylene of the examples is understood to be a conventional propylene homopolymer, having a melting temperature of 162° C. or higher.

Moreover, according to the technical solution disclosed in the said document, it is necessary for the additive compositions to contain specific nucleating agents in specific weight proportions with the said polypropylene, and the granulation temperature is required to be of 150° C. or higher.

It would be therefore desirable to make it possible to prepare non-powdery compositions of additives with a less demanding process in terms of temperatures and kinds and amounts of components required (with particular reference to the amount of components different from additives), while avoiding the losses of yield due to separation of powders.

Thus an object of the present invention is represented by compositions of additives for plastics, comprising the following components (percent by weight):
A) from 1% to 25%, preferably from 1% to 20%, more preferably from 3% to 15%, of a polyolefin matrix comprising one or more polyolefins having a melting point of 160° C. or less, preferably of 150° C. or less, more preferably 140° C. or less, even more preferably of 125° C. or less, most preferably of 120° C. or less, said melting point being determined by differential scanning calorimetry (DSC), according to ISO 11357, Part 3, with a heating rate of 20° C./minute;
B) from 75% to 99%, preferably from 80% to 99%, more preferably from 85% to 97%, of one or more solid additives for polymers.

The said melting point of the polyolefin(s) present in component (A) can be generally determined in the first and/or in the second heating run. According to the present invention it is sufficient that the said polyolefin(s) have a melting point equal to or lower than the said upper limits, when measured in either the first or in second heating run. Obviously both the two values measured in the first and in the second heating run can be equal to or lower than the said upper limits.

Preferably, when a propylene homopolymer is present in (A), at least one additional polyolefin selected from butene-1 homopolymers or copolymers, or ethylene homopolymers or copolymers, is present in amounts from 1% to 20%, more preferably from 3% to 15%, most preferably from 3% to 10%, referred to the total weight of (A)+(B).

The same additional polyolefin(s) in the previously said amounts can be present even when component (A) comprises a propylene copolymer.

Preferably, the compositions of the present invention are characterized by the fact of having at least one melting peak, measured by DSC, in the first and/or in the second heating run, at a temperature different from the melting temperature of the polyolefin(s) present in component (A). Such melting peak or peaks are present at temperatures generally higher tan 50° C.

Said compositions of additives achieve a very favorable compromise between compactness, such that their components are not disaggregated during handling and transportation, and no dust is thus generated, and capability to undergo crushing when compounded to virgin polymers, thus enabling to achieve an optimal distribution of the additives in the final polymer/item composition.

Clearly, for “solid additives” it is meant that such additives are in the solid state at room temperature (about 25° C.).

The component (A) is preferably present in the compositions of additives of the present invention in the form of relatively large domains, as opposed to powder which is characterized by a fine subdivision, typically with an average particle size of 100 μm or less. However, minor amounts of powder of component (A), namely of less than 10% by weight referred to the weight of (A), can be present and tolerated.

More preferably the polyolefin matrix (A) is a coherent phase, which gives a very high resistance to separation of fine powder (hereinafter referred to as “pulverization”) to the compositions of additives, under the conditions normally used during transportation and processing of polymers. Such resistance to pulverization can be expressed in terms of a “cohesion degree” by determining the amount of powder generated under the said conditions and having a sufficient degree of fineness.

Such parameter is particularly important because, in the industrial practice, while handling powders, fines generation has to be minimized. This not only for hygiene reasons, but also to reduce explosion risks. In fact it is well known that fine particles (typical size below 200 μm) can be harmful and are considered potentially explosive.

Once produced, the compositions of additives have to be transported, stored and fed to the processing equipments to be added to the polymer. During these operations, as an effect of the attrition or mechanical stress applied, the compositions might break producing dust. In particular, the cohesion degree can be determined with the method reported in the examples.

Preferred values of cohesion degree for the compositions of the present invention are of less than 1% by weight, more preferably less than 0.5% by weight of powder having diameter of less than 212 μm, separated from the compositions of additives in a screw feeder operated at 30 rpm (revolutions per minute), said amounts being referred to the initial weight of the composition of additives before passing through the screw feeder.

As will be explained later in detail, such form of the component (A) can be achieved by mixing together the two components (A) and (B) and bringing component (A) into the molten state, in particular by extrusion.

The preparation process is another object of the present invention.

In addition to the said solid additives (B), the compositions of the present invention can also contain liquid additives, provided that they do not alter too much the compactness of the said compositions.

Generally the additives in liquid form can be present in weight amounts, referred to the total weight of the compositions, of less than 10%, in place of an equivalent weight of component (B).

Examples of additives that can be employed as component (B) or as additional liquid additives are hereinafter given.

### 1) Stabilisers.

Specific examples of stabilizers are:
antacids, such as stearates, like calcium stearate, zinc stearate, sodium stearate, carbonates, and synthetic hydrotalcite;
light and thermal stabilizers, such as hindered amines, dimethyl-succinate polymer with 4-hydroxyl-[2,2,6,6 tetramethyl]-1-peperidinyl ethanol or N-N¹ bis[2,2,6,6 tetramethyl 4-piperidinyl]-1-6hexane diamine polymer with 2,4,6 trichloro 1,3,5 triazine and 2,4,4 trimethyl 1,2-pentanamine or oligomeric polysiloxane hindered amines, low basicity N-methyl or N-alkyl hindered amines, for instance polymethylpropyl 3-oxy-[4(2,2,6,6 tetramethyl)piperidinyl] siloxane or bis-(1-octyloxy-2,2,6,6,tetramethyl-4-piperidinyl)sebacate or N-butyl-2,2,6,6-teramethyl-4-piperidinamine or 4-amino-2,2,6,6-tetra methylpiperidine;
antioxidants, such as hindered phenols, for instance tetrakis 3-(3,5-di-t-butyl-4-hydroxyphenyl) propionyloxymethyl-methane, hindered phenolic isocyanurate or melt stabilisers like phosphates, phosphites or phosphonites, such as 2,4 tert butylphenyl triphosphate or tri(nonyl phenyl) phosphite or octyl diphenyl phosphite;
thermal stabilizers such as thioesters and thioethers, for instance pentaerythrityl hexylthiopropionate or distearyl thiodipropionate.

### 2) Processing adjuvants and modifiers.

Specific examples are:
lubricant and antistatic agents, as for example glyceryl monostearate, waxes and paraffin oils and ethoxylated amines;
nucleating agents, for example dibenzylidene sorbitol, carboxylic organic acids and their salts, such as adipic and benzoic acid, sodium benzoate and adipate;
“slip agents”, such as erucamide and oleamide;
anti-fogging and antistatic agents (for example sorbitan esters, glycerol esters, glycerol fatty acid esters, alkyl sulphonates, penta-erythritol esters, ethoxylated synthetic amines, polyoxyethylene sorbitan laurate, glycerol oleate).

Preferred additives for use as component (B) in the compositions of the present invention are the said stabilizers.

Generally, the olefin polymers that can be present in component (A) of the compositions of the present invention are homopolymers or copolymers, and their mixtures, of R—CH═CH₂ olefins where R is a hydrogen atom or a C₁-C₈ alkyl or cycloalkyl radical. Particularly preferred are the butene-1 or ethylene homopolymers and copolymers.

As previously said, propylene homopolymers and copolymers can be used as well.

Preferred values of Melt Flow Rate (MFR) and intrinsic viscosity [η] for the said olefin polymers and their mixtures are:

### MFR: 2-3000 g/10 min., more preferably 30-3000 g/10 min., most preferably 50-3000 g/10 min., in particular 50-2000 or 50-1000 g/10 min.; specific preferred values are reported hereinafter for LDPE;

[η]: 0.5 dl/g or more, in particular, and preferably for butene-1 or propylene homopolymers or copolymers, 0.5-1.5 dl/g, more preferably 0.5-1.2 dl/g, measured in tetrahydronaphthalene at 135° C.

The said MFR values are measured under the conditions typically adopted for olefin polymers, in particular according to ASTM D1238 at 190° C./2.16 kg for butene-1 and ethylene polymers and according to ASTM D1238 at 230° C./2.16 kg for propylene polymers.

When consisting of or comprising a butene-1 homopolymer or copolymer, or their mixtures, the component (A) of the present invention is preferably present in amounts of from 1% to 15% by weight, more preferably from 3% to 15% by weight.

The melting point of the butene-1 homopolymers or copolymers is preferably determined in the first heating run.

Generally for the other polyolefins the melting point is preferably determined in the second heating run.

The polybutene-1 preferably employed in the compositions of additives of the present invention is a linear homopolymer that is semicrystalline and highly isotactic (having in particular an isotacticity from 90 to 99%, preferably from 95 to 99%, measured both as mmmm pentads/total pentads using NMR and as quantity by weight of matter soluble in xylene at 0° C.), typically obtained by polymerization of butene-1 with a stereospecific catalyst.

In the case when a copolymer of butene-1 is used, the isotacticity index can be expressed as the fraction that is insoluble in xylene, still at 0° C., and is preferably greater than or equal to 60%. Preferably the polybutene-1 used in the compositions of additives of the present invention has a melting point from 80 to 125° C., more preferably from 100 to 125° C.

An advantage of using homopolymers and copolymers of butene-1 is represented by their low melting point (in particular, about 110-138° C. for the homopolymers) which makes it possible to avoid degradation of the additives and achieve low energy consumption in the preparation of the compositions of additives of the present invention.

Moreover, the said homopolymers and copolymers of butene-1 are particularly suited for incorporation of the additives because of their wetting ability in the molten state and for the easy incorporation into the final product, particularly when their MFR is relatively high, such as of 50 g/10 min. or more, in particular of 80 g/10 min. or more, measured according to ASTM D1238, at 190° C./2.16 kg.

Suitable copolymers of butene-1 are preferably those containing up to 30 mol. % of olefinic comonomers. The said comonomers are generally selected from ethylene, propylene or R—CH═CH₂ olefins where R a C₃-C₈ alkyl or cycloalkyl radical (in particular ethylene, propylene or alpha-olefins containing from 5 to 8 carbon atoms). The said homo- and copolymers can be obtained by low-pressure Ziegler-Natta polymerization of butene-1, for example by polymerizing butene-1 (and any comonomers) with catalysts based on TiCl₃, or halogenated compounds of titanium (in particular TiCl₄) supported on magnesium chloride, and suitable co-catalysts (in particular alkyl compounds of aluminium). High values of MFR can be obtained directly in polymerization or by successive chemical treatment of the polymer.

As disclosed for instance in WO 03/042258, the butene polymers can also be prepared by polymerization in the presence of catalysts obtained by contacting a metallocene compound with an alumoxane.

The PB0800M polybutene-1 (sold by Basell) is an example of butene-1 polymers particularly suitable for use in the compositions of additives of the present invention. This is a homopolymer having a melt flow rate of 200 g/10 min at 190° C./2.16 kg.

When consisting of or comprising an ethylene homopolymer or copolymer, or their mixtures, the component (A) of the present invention is preferably present in amounts of from 1% to 20% by weight, more preferably from 5% to 15% by weight.

The ethylene polymers that can be used in the compositions of additives of the present invention can be selected in the group consisting of HDPE (High Density Polyethylene, typically having a density from 0.940 to 0.965 g/cm³), MDPE (Medium Density Polyethylene, typically having a density from 0.926 to 0.940 g/cm³) LLDPE (Linear Low Density Polyethylene, typically having a density 0.900 to 0.939 g/cm³), and LDPE (Low Density Polyethylene). LDPE is preferred.

In particular, the LDPE that can be used for component (A) is an ethylene homopolymer or an ethylene copolymer containing minor amounts of other comonomers, like butyl acrylate, prepared by high pressure polymerization using free radical initiators.

The density of said LDPE typically ranges from 0.917 to 0.935 g/cm³, measured according to the standard ISO 1183.

The MFR of said LDPE is preferably from 2 to 50 g/10 min., more preferably from 5 to 40 g/10 min. at 190° C./2.16 kg.

The melting point is generally from 90 to 120° C.

Such kinds of LDPE are well known in the art and available on the market. Specific examples are the polymers available under the tradenames Escorene and Lupolen.

The propylene polymers that can be used in the compositions of additives of the present invention can be isotactic crystalline homopolymers or copolymers of propylene.

Among the copolymers, the isotactic crystalline copolymers of propylene with ethylene and/or CH₂═CHR alpha-olefins in which R is an alkyl or cycloalkyl radical with 2-8 carbon atoms (for example butene-1, hexene-1, octene-1), containing more than 85 wt. % of propylene, are suitable. The isotacticity index of the aforesaid polymers of propylene is preferably greater than or equal to 85%, more preferably greater than or equal to 90%, measured as the fraction that is insoluble in boiling heptane or in xylene at room temperature, or by determining the amount of isotactic pentads in the polymer chain by ¹³C NMR. Preferably, the MFR values for the propylene polymers is of 50 g/10 min or higher. Propylene homopolymers having a melting point of 160° C. or less can be obtained by the metallocene catalyzed polymerization of propylene. In such catalysis the polymerization catalyst comprises the reaction product of a metallocene and a compound such as an alumoxane, trialkyl aluminum or an ionic activator. A metallocene is a compound with at least one cyclopentadienyl moiety in combination with a transition metal of Groups IV-VIII of the Periodic Table.

Examples of said homopolymers are disclosed in U.S. Pat. No. 6,037,417.

Also in the case of the propylene polymers, particularly high values of MFR can be obtained directly in polymerization or by successive chemical treatment of the polymer (chemical visbreaking).

The chemical visbreaking of the polymer is carried out in the presence of free radical initiators, such as the peroxides. Examples of radical initiators that can be used for this purpose are the 2,5-dimethyl-2,5-di(tert-butylperoxide)-hexane and dicumyl-peroxide.

The visbreaking treatment is carried out by using the appropriate quantifies of free radical initiators, and preferably takes place in an inert atmosphere, such as nitrogen. Methods, apparatus, and operating conditions known in the art can be used to carry out this process. As previously mentioned, another object of the present invention is represented by a process for producing the said compositions of additives, by mixing together the polyolefin component (A) and the additive component (B) at a temperature sufficient to melt at least one of the polyolefin(s) present in component (A), preferably sufficient to melt the whole component (A), which temperature is obviously higher than the melting point of the said polyolefin(s).

By melting, totally or partially, the polyolefin component (A) during the mixing step, which is preferably carried out by extrusion, the presence of powders of polyolefin component (A) is avoided or at least reduced to the previously said amounts.

A particularly advantageous aspect of the process of the present invention is that the said extrusion can be carried out in the extruders normally used for processing the thermoplastic polymers, like polyolefins.

Thus, in order to prepare the strands one can use extruders commonly known in the art, including single-screw extruders, traditional and CoKneader (like the Buss), twin corotating screw extruder, mixers (continuous and batch). Such extruders are preferably equipped with separate feeding systems for the polyolefin component (A) and for the additive component (B) respectively. The additive component (B) can be added to the polymer mass inside the extruder, either in the same feed port or downstream from the point at which the solid polymer is fed into the extruders, so that the distance between will allow the polymer to have reached the form of a melted, homogeneous mass. The processing extruder temperatures preferably range from 100° C. to 220° C., more preferably from 100 to 200° C., most preferably 100 to 170° C., in particular from 100 to 140° C.

The additive component (B) is generally added in form of powder, preferably with an average particle size of 100 μm or less, but it can also be added in other forms, like flakes. When more than one additive are used as component (B), the single additives can be added preferably separately using dedicated feeders or mixed together in advance (premix). To carry out the said premixing step, any method and apparatus used in the art can be adopted; preferably medium and high speed mixers are used.

When liquid additives are part of the component (B), they are fed preferably into the extruder by means of a dosing pump.

The polyolefin component (A) can be added in any form, for instance in form of pellets, flakes or powders.

The continuous strands exiting from the extruder dies can be cut in segments, by way of rotating blades for example, thus obtaining the pellets of the present invention, which are later on cooled, preferably by means of a gaseous medium (in particular, air or nitrogen). Alternatively, the strands can be cut after cooling to obtain the said pellets of the present invention, using for instance a steel belt cooling system. The strands can also be dripped onto the steel belt cooling system still in the molten state, forming in this way the pellets of the present invention.

As previously mentioned, the strands are generally characterized by SL/CL ratios higher than 2, preferably higher than 5, while pellets are characterized by SL/CL ratios of less than 5, preferably 1 to 3. The pellets can also have a roughly spherical shape (for instance when they are cut from a strand containing relatively high amount of polyolefin component (A) still in the molten or softened state), so that they can be also defined as “beads”.

The compositions of additives of the present invention can be used directly in the polymer processing apparatuses to introduce additives in the polymer compositions, thus obtaining a very good dispersion of the additives in the polymer mass. They are in fact characterized, as previously mentioned, by many advantageous properties, among which:
1. good storage stability and resistance to damage during transport;
2. high additive content;
3. high compatibility of the polyolefin component (A) with many polymeric materials.

In particular, the compositions of additives of the present invention can be used advantageously to introduce the additives in thermoplastic and elastomeric polyolefins, like polyethylene, polypropylene, polybutene, ethylene/propylene rubbers (EPR), ethylene/propylene/diene rubbers (EPDM), and their mixtures.

The following examples are given for illustrating but not limiting purposes.

The following analytical methods have been used to determine the properties reported in the description and in the examples.

### Melting Point

The Melting Point™ values are determined using the following procedure according to ISO 11357 Part 3.

Differential scanning calorimetric (DSC) data is obtained using a DSC Q1000 TA Instruments. Samples weighing approximately 6-8 mg are sealed in aluminum sample pans. The samples are subjected to a first heating run from 5° C. to 200° C. with a heating rate of 20° C./minute, and kept at 200° C. under isothermal conditions for 5 minutes. Then the samples are cooled from 200° C. to 5° C. with a cooling rate of 20° C./minute, and kept at 5° C. under isothermal conditions for 5 minutes, after which they are subjected to a second heating run from 5° C. to 200° C. with a heating rate of 20° C./minute. The melting point can be determined either in the first or in the second heating run, or in both the two runs. It is preferably determined in the first heating run for butene-1 homopolymers and copolymers, and in the second for ethylene or propylene homopolymers and copolymers.

### Cohesion Degree

The tendency to produce fines (coherence degree) for the different samples is measured according to the following procedure. Each sample is previously sieved to remove particles with a size of less than 212 μm. 250 g of the sieved sample is loaded in a screw feeder operated at 30 rpm. Such feeder is equipped with a screw having length of 315 mm, internal diameter of 27 mm, external diameter (including the screw helix) of 41 mm, helix pitch of 20 mm and 16 helix turns. The pellets discharged from the feeder are passed through the same 212 μm sieve to remove the fines generated during the pass through the screw. The cycle is repeated 5 times. The final sample not passed through the sieve is weighed to measure the amount of “dust” generated. The ratio by mass of fines generated to the initial weight is obtained.

### Determination of Solubility in Xylene at 0° C. (% by Weight)

2.5 g of polymer are dissolved in 250 ml of xylene, at 135° C., under agitation. After 20 minutes, the solution is cooled to 0° C. under stirring, and then it is allowed to settle for 30 minutes. The precipitate is filtered with filter paper; the solution is evaporated under a nitrogen current, and the residue dried under vacuum at 140° C. until constant weight. The weight percentage of polymer soluble in xylene at 0° C. is then calculated. The percent by weight of polymer insoluble in xylene at room temperature is considered the isotactic index of the polymer.

### Determination of Solubility in Xylene at Room Temperature (% by Weight)

2.5 g of polymer are dissolved in 250 ml of xylene, at 135° C., under agitation. After 20 minutes, the solution is cooled to 25° C. under stirring, and then it is allowed to settle for 30 minutes. The precipitate is filtered with filter paper; the solution is evaporated under a nitrogen current, and the residue dried under vacuum at 80° C. until constant weight. The weight percentage of polymer soluble in xylene at room temperature is then calculated. The percent by weight of polymer insoluble in xylene at room temperature is considered the isotactic index of the polymer. This value corresponds substantially to the isotactic index determined by extraction with boiling n-heptane, which by definition constitutes the isotactic index of polypropylene.

### Determination of Isotacticity Index by ¹³C-NMR

### Propylene Polymers

The proton and carbon spectra of polymers are obtained using a Bruker DPX 400 spectrometer operating in the Fourier transform mode at 120° C. at 400.13 MHz and 100.61 MHz respectively. The samples are dissolved in C₂D₂Cl₄. As reference the residual peak of C₂DHCl₄ in the ¹H spectra (5.95 ppm) and the peak of the mmmm pentad in the ¹³C spectra (21.8 ppm) are used. Proton spectra are acquired with a 450 pulse and 5 seconds of delay between pulses; 256 transients are stored for each spectrum. The carbon spectra are acquired with a 90° pulse and 12 seconds (15 seconds for ethylene based polymers) of delay between pulses and CPD (waltz 16) to remove ¹H-¹³C couplings. About 3000 transients are stored for each spectrum. mmm pentads are calculated according to Randall, J. C. Polymer Sequence Determination; Academic Press: New York, 1977.

### Butene-1 Polymers

¹³C-NMR spectra are acquired on a DPX-400 spectrometer operating at 100.61 MHz in the Fourier transform mode at 120° C. The samples are dissolved in 1,1,2,2-tetrachloroethane-d2 at 120° C. with a 8% wt/v concentration. Each spectrum is acquired with a 90° pulse, 15 seconds of delay between pulses and CPD (waltz16) to remove ¹H-¹³C coupling. About 3000 transients are stored in 32K data points using a spectral window of 6000 Hz. The isotacticity is defined as the relative intensity of the mmmm triad peak of the diagnostic methylene of the ethyl branch. This peak at 27.73 ppm is used as internal reference. Pentad assignments are given according to Macromolecules, 1992, 25, 6814-6817.

### EXAMPLE 1

A Corotating Twin Screw extruder, namely Maris 45TM, with process length 36 L/D (Length/Diameter ratio), coupled to a hot face cutting system (2 holes and 4 knives) with air cooling was used to prepare a composition of additives by extruding the following components (percent amounts by weight):

### A)—9.1% of butene-1 homopolymer (PB), with MFR (190° C./2.16 kg) of 50 g/10 min., melting point Tm1, measured in the first heating run of, 121° C., and isotacticity index of 98%, in form of pellets;

### B^{I})—22.7% of Irganox 1010 (Ciba), which is made of pentaerytrityl tetrakis 3-(3,5-di-tert-butyl-4-hydroxyphenyl) propanoate, in form of powder;

### B^{II})—44.5% of Irgafos 168 (Ciba), which is made of tris (2,4-di-tert-butylphenyl) phosphite, in form of powder;

### B^{III})—22.7% of calcium stearate, in form of powder.

Being the line equipped with two feed ports, the first port was used as main feed port. The second one, situated at approximately 12 D (Diameters) after main feed port, was fed through a side feeder.

Components A), B^{I}) and B^{II}) were fed as individual components with 3 separate Loss in Weight feeders (Main1, Main2 and Main 3) to the main feed port and component B^{II}) was fed with a fourth Loss in Weight feeder (Side1) to the second feed port.

The following settings were used:

total capacity of 22 kg/h, with extrusion speed of 180 rpm and extruder temperature of 120° C.; the cutting system was set at 130° C. and the cutting speed at 1000 rpm, with cooling air at 15° C.

Dust-Free pellets were in this way collected. The cohesion degree value is reported in Table 1.

### COMPARATIVE EXAMPLE 1

Using the same extrusion equipment of Example 1, a composition of additives was prepared by extruding the hereafter described components.

### B^{I})—25% of Irganox 1010 in form of powder;

### B^{II})—50% of Irgafos 168 in form of powder;

### B^{III})—25% of calcium stearate in form of powder.

The extrusion was carried out using respectively (for the said three components) feeders Main2, Side1 and Main3, at a total capacity of 20 kg/h, with extrusion speed of 180 rpm and extruder temperature of 120° C. The cutting system was set at 130° C. and the cutting speed at 1000 rpm, with cooling air at 15° C.

It was not possible to collect coherent pellets that were actually broken into small particles due to their poor mechanical strength.

### EXAMPLE 2

By operating with the same extrusion equipment and method as in Example 1, a composition of additives was prepared by extruding the hereafter described components.

### A)—9.1% of LDPE with MFR (190° C./2.16 kg) of 36 g/10 min., density of 0.924 g/cm³ (ISO1183), melting temperature 112° C., in form of pellets;

### B^{I})—22.7% of Irganox 1010 in form of powder;

### B^{II})—44.5% of Irgafos 168 in form of powder;

### B^{III})—22.7% of calcium stearate, in form of powder,

The extrusion was carried out using respectively feeders Main1, Main2, Side1 and Main3, at a total capacity of 22 kg/h, with extrusion speed of 180 rpm and extruder temperature of 120° C. The cutting system was set at 130° C. and the cutting speed at 1000 rpm, with cooling air at 15° C.

Dust-Free pellets were in this way collected. The cohesion degree value is reported in Table 1.

### EXAMPLE 3

By operating with the same extrusion equipment and method as in Example 1, a composition of additives was prepared by extruding the hereafter described components.

### A)—9.1% of the same butene-1 homopolymer as in Example 1, in form of pellets;

### B^{I})—18.2% of Irganox 1010 in form of powder;

### B^{II})—36.4% of Irgafos 168 in form of powder;

### B^{III})—36.4% of sodium benzoate Mi.Na.08 (Adeka Palmarole), in form of micronised powder.

The extrusion was carried out using respectively feeders Main1, Main2, Side1 and Main3, at a total capacity of 22 kg/h, with extrusion speed of 180 rpm and extruder temperature of 120° C. The cutting system was set at 130° C. and the cutting speed at 750 rpm, with cooling air at 15° C.

Dust-Free pellets were in this way collected. The cohesion degree value is reported in Table 1.

### EXAMPLE 4

By operating with the same extrusion equipment and method as in Example 1, a composition of additives was prepared by extruding the hereafter described components.

### A)—13.0% of the same LDPE as in Example 2, in form of pellets;

### B^{I})—17.4% of Irganox 1010 in form of powder;

### B^{II})—34.8% of Irgafos 168 in form of powder;

### B^{III})—34.8% of sodium benzoate Mi.Na.08, in form of micronised powder.

The extrusion was carried out using respectively feeders Main1, Main2, Side1 and Main3, at a total capacity of 23 kg/h, with extrusion speed of 180 rpm and extruder temperature of 120° C. The cutting system was set at 130° C. and the cutting speed at 750 rpm, with cooling air at 15° C.

Dust-Free pellets were in this way collected. The cohesion degree value is reported in Table 1.

### EXAMPLE 5

By operating with the same extrusion equipment and method as in Example 1, a composition of additives was prepared by extruding the hereafter described components.

### A)—13.0% of the same LDPE as in Example 2, in form of pellets;

### B^{I})—24.9% of Irganox 1010 in form of powder;

### B^{II})—24.9% of Irgafos 168 in form of powder;

### B^{III})—37.2% of sodium benzoate Mi.Na.08, in form of micronised powder.

The extrusion was carried out using respectively feeders Main1, Main2, Side1 and Main3, at a total capacity of 23 kg/h, with extrusion speed of 180 rpm and extruder temperature of 120° C. The cutting system was set at 130° C. and the cutting speed at 750 rpm, with cooling air at 15° C.

Dust-Free pellets were in this way collected. The cohesion degree value is reported in Table 1.

### EXAMPLE 6

A Corotating Twin Screw extruder, namely Leistritz Micro27, with process length 40 L/D, coupled to a hot face cutting system (2 holes of 3 mm diameter, and 4 knives) with air cooling was used to compound a composition comprising the hereafter described components.

### Component (A)

Butene-1 copolymer (hereinafter called PB) with 2% by weight of ethylene, having a MFR of 200 g/10 min. (measured according to ASTM D1238, at 190° C./2.16 kg), a melting point Tm1 of 112° C. and an isotacticity index of 83%.

### Component (B)

Additive premix made of (percent by weight):

25% of Irganox 1010 in form of powder;
50% of Irgafos 168 in form of powder;
25% of calcium stearate, in form of powder.

The premix is obtained by mixing together the said additives in a Turbomixer, operating for 3 minutes at 500 rpm and then for 3 minutes at 800 rpm.

Being the line equipped with two feed ports, the first port was used as main feed port. The second one, situated at approximately 12 D after main feeding port, was fed through a side feeder.

Component (A) was fed with a dedicated Loss in Weight feeder (Main1) to the main feed port and component (B) was fed with a dedicated Loss in Weight side feeder (Side1) to the second feed port.

Extruded strands were prepared using respective concentration of components (A) and (B) of 5% (A)/95% (B), 10% (A)/90% (B) and 20% (A)/80% (B), at a total capacity of 10 kg/h, with extrusion speed of 220 rpm and extruder temperature of 120° C. The cutting system was set at 130° C.

Strands exiting the die were cut by way of rotating blades, thus obtaining pellets

Dust-Free pellets were in this way collected even with the lowest PB amount.

### EXAMPLE 7

By using the compounding method of Example 6, a composition comprising the hereafter described components was prepared.

### Component (A)

Propylene homopolymer Metocene X50128 (Basell), having a MFR of 2300 g/10 min. (measured according to ASTM D1238, at 230° C./2.16 kg), a melting point of 143.1° C. and isotacticity index of 92%.

### Component (B)

Additive premix made of (percent by weight):

13.1% of Irganox 1010 in form of powder;
26.4% of Irgafos 168 in form of powder;
13.1% of calcium stearate, in form of powder.
47.4% of Millad 3988 (Milliken) made of 2,4-di(3,4-dimethylbenzylidene)-D-sorbitol.

The premix is obtained by mixing together the said additives in a Turbomixer, operating for 3 minutes at 500 rpm and then for 3 minutes at 800 rpm.

Being the line equipped with two feed ports, the first port was used as main feed port. The second one, situated at approximately 12 D after main feeding port, was fed through a side feeder.

Component (A) was fed with a dedicated Loss in Weight feeders (Main1) to the main feed port and component (B) was fed with a dedicated Loss in Weight side feeder (Side1) to the second feed port.

Extruded strands were prepared using respective concentration of components (A) and (B) of 10%/90%, at a total capacity of 5 kg/h, with extrusion speed of 160 rpm and extruder temperature of 160° C. The cutting system was set at 140° C. A die plate with 1 hole of 3 mm diameter was used.

The strands exiting the die were cut by way of rotating blades, thus obtaining pellets. Dust-Free pellets were in this way collected.

### APPLICATIVE EXAMPLE 1

Approximately 500 kg of pellets produced in accordance with Example 1 (Composition 1), were used in a polypropylene plant to compound 250 ton of propylene homopolymer, using a Twin Screw Extruder, Model Werner&Pfleiderer ZSK300, at a total capacity of 18 ton/h. Composition 1 was fed to the polypropylene flakes at a ratio of 1.9 kg per ton, through a dedicated Loss In Weight Feeder, with automatic refilling system through IBC (Intermediate Bulk Container).

The average MFR, measured at 230° C. and 2.16 kg was 11.8 g/10 min (which is substantially the same as the value of the polypropylene flakes before compounding), with a Yellow Index value of −1.4 measured on pellets (according to method ASTM E313-95). Both results have been considered fully in specification and aligned to values obtained with pure additives.

TABLE 1

| | Component (A) | Cohesion degree |
|---|---|---|
| Example | (% wt) | % wt fines (<212 μm) |
| Example 1 | PB (9.1) | 0.43 |
| Comparative | — (0) | 6.23 |
| Example 1 | | |
| Example 2 | LDPE (9.1) | 0.46 |
| Example 3 | PB (9.1) | 0.07 |
| Example 4 | LDPE (13.0) | 0.11 |
| Example 5 | LDPE (13.0) | 0.01 |

1. Compositions of additives for plastics comprising the following components (percent by weight):
(A) from 1% to 25% of a polyolefin matrix comprising at least one polyolefin having a melting point of at most 160° C., said melting point being determined by differential scanning calorimetry (DSC), according to ISO 11357, Part 3, with a heating rate of 20° C./minute; and
(B) from 75% to 99% of at least one solid additive for polymers.

2. The compositions of additives according to claim 1, further comprising a cohesion degree of less than 1% by weight of powder having diameter of less than 212 μm, separated from the compositions in a screw feeder operated at 30 rpm.

3. The compositions of additives according to claim 1, wherein the polyolefin matrix is prepared by melting the at least one polyolefin present in component (A).

4. The compositions of additives according to claim 1, in form of strands.

5. The compositions of additives according to claim 1, in form of pellets.

6. The compositions of additives according to claim 1, wherein the at least one polyolefin of component (A) is selected from homopolymers or copolymers, and their mixtures, of R—CH═CH₂ olefins where R is a hydrogen atom or a C₁-C₈ alkyl or cycloalkyl radical.

7. The compositions of additives according to claim 6, wherein component (A) comprises a butene-1 homopolymer or copolymer.

8. The compositions of additives according to claim 6, wherein component (A) comprises a LDPE.

9. The compositions of additives according to claim 6, wherein component (A) comprises a propylene homopolymer or copolymer.

10. The compositions of additives according to claim 1, further comprising less than 10% of liquid additive(s), in place of an equivalent weight of component (B).

11. The compositions of additives according to claim 1, wherein component (B) is selected from stabilizers, processing adjuvants and modifiers, and mixtures thereof.

12. A process for preparing compositions comprising the following components (percent by weight):
(A) from 1% to 25% of a polyolefin matrix comprising at least one polyolefin having a melting point of at most 160° C., said melting point being determined by differential scanning calorimetry (DSC), according to ISO 11357, Part 3, with a heating rate of 20° C./minute; and
(B) from 75% to 99% of at least one solid additive for polymers,
the process comprising a step of mixing the polyolefin component (A) with the additive component (B) at a temperature higher than the melting point of the at least one polyolefin of component (A).

13. The process of claim 12, wherein the mixing step is carried out by extrusion.

14. A process comprising adding a composition of additives to polymers, the composition of additives comprising the following components (percent by weight):
(A) from 1% to 25% of a polyolefin matrix comprising at least one polyolefin having a melting point of at most 160° C., said melting point being determined by differential scanning calorimetry (DSC), according to ISO 11357, Part 3, with a heating rate of 20° C./minute; and
(B) from 75% to 99% of at least one solid additive for polymers.

15. Polymers containing compositions of additives comprising the following components (percent by weight):
(A) from 1% to 25% of a polyolefin matrix comprising at least one polyolefin having a melting point of at most 160° C., said melting point being determined by differential scanning calorimetry (DSC), according to ISO 11357, Part 3, with a heating rate of 20° C./minute; and
(B) from 75% to 99% of at least one solid additive for polymers.
